(19) United States
(12) Patent Application Publication
(10) Pub. No.: US 2025/0282369 A1
(43) Pub. Date: Sep. 11, 2025

(54) VEHICLE

(71) Applicant: HONDA MOTOR CO., LTD., Tokyo (JP)

(72) Inventor: Sho SASAKI, Tokyo (JP)

(73) Assignee: HONDA MOTOR CO., LTD., Tokyo (JP)

(21) Appl. No.: 19/056,779

(22) Filed: Feb. 19, 2025

(30) Foreign Application Priority Data
Mar. 11, 2024 (JP) 2024-037110

(51) Int. Cl. B60W 50/08; B60W 10/04; B60W 10/18; B60W 50/14

(52) U.S. Cl. CPC B60W 50/085; B60W 10/04; B60W 10/18; B60W 50/14; B60W 2540/10; B60W 2540/12; B60W 2710/18; B60W 2720/106

(57) ABSTRACT

A vehicle includes: an operator operable by a driver; a control device configured to control a predetermined control target in accordance with an operation of the operator; and a vehicle control device configured to control the control device. The control device has a first state in which an operation of the operator is reflected in control of the control target and a second state in which an operation of the operator is not reflected in control of the control target, and is configured to switch between the first state and the second state, and the vehicle control device includes circuitry configured to: acquire information related to a travel state of the vehicle; and switch the control device from the first state to the second state according to the acquired travel state.

### CROSS-REFERENCE TO RELATED APPLICATIONS

This application is based on and claims priority under 35 USC 119 from Japanese Patent Application No. 2024-037110 filed on Mar. 11, 2024, the contents of which are incorporated herein by reference.

### TECHNICAL FIELD

The present disclosure relates to a vehicle.

### BACKGROUND

In recent years, active efforts have been made to provide access to a sustainable transportation system in consideration of vulnerable traffic participants. As one of these efforts, research and development on driving assistance techniques and automated driving techniques for vehicles such as automobiles have been made in order to further improve safety and convenience of traffic.

For example, in the related art, a system that controls a vehicle without intervention of an operation by a driver when an abnormality occurs in a driver is known.

As an example of such a system, United States Patent Application Publication No. 2015/0329091 described below discloses a technique in which a system such as an Automatic Emergency Braking (AEB) or Dynamic Brake Support (DBS) system applies brakes, and only when it is determined that driving ability of a driver is not impaired, the system permits “the driver to disable braking provided by the system (in other words, to override the system).”

However, in the related art, a point of switching to a state in which an operation of an operator operable by a driver is not reflected in control (that is, overriding the system) is not sufficiently considered, and there is room for improvement in this point.

The present disclosure provides a vehicle capable of appropriately switching to a state where an operation of an operator operable by a driver is not reflected in control.

### SUMMARY

An aspect of the present disclosure relates to a vehicle including:
an operator operable by a driver;
a control device configured to control a predetermined control target in accordance with an operation of the operator; and
a vehicle control device configured to control the control device, in which
the control device has a first state in which an operation of the operator is reflected in control of the control target and a second state in which an operation of the operator is not reflected in control of the control target, and is configured to switch between the first state and the second state, and
the vehicle control device includes circuitry configured to:
acquire information related to a travel state of the vehicle; and
switch the control device from the first state to the second state according to the acquired travel state.

According to the present disclosure, it is possible to provide the vehicle capable of appropriately switching to a state where an operation of an operator operable by a driver is not reflected in control. Further, it is possible to improve traffic safety and contribute to development of a sustainable transportation system.

### BRIEF DESCRIPTION OF DRAWINGS

Exemplary embodiments of the present disclosure will be described in detail based on the following figures, wherein:

FIG. 1 is a block diagram showing a schematic configuration of a vehicle including a control device according to an embodiment;

FIG. 2 is a flowchart showing an example of processing (switching from a first state to a second state) executed by the control device according to the embodiment; and

FIG. 3 is a flowchart showing an example of processing (switching from the second state to the first state) executed by the control device according to the embodiment.

### DESCRIPTION OF EMBODIMENTS

Hereinafter, an embodiment of a vehicle control device according to the present disclosure will be described with reference to the drawings. The following embodiment does not limit the present disclosure, and not all of elements described in the following embodiment are necessary to the present disclosure. Two or more elements described in the following embodiment may be freely combined without departing from the gist of the present disclosure. Hereinafter, the same or similar elements are denoted by the same or similar reference signs, and a description thereof may be omitted or simplified.

### Vehicle

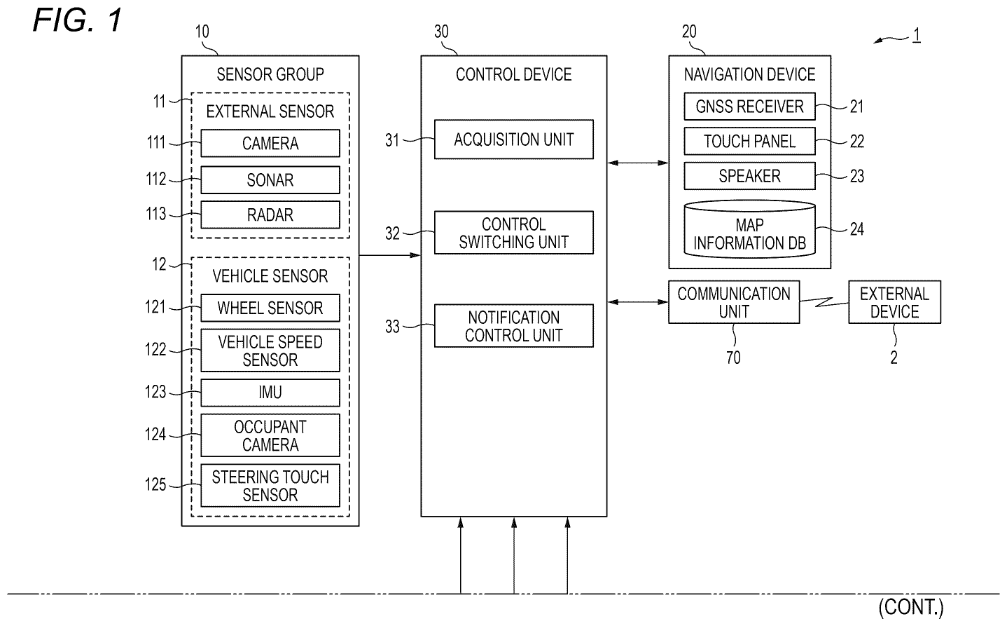

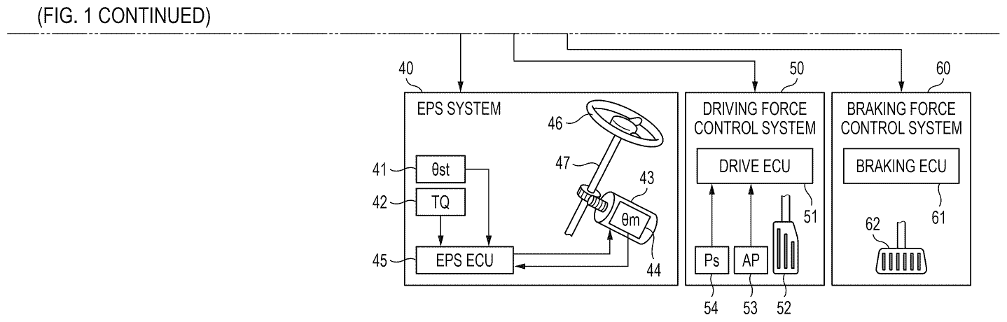

First, a vehicle according to the present embodiment will be described. A vehicle 1 according to the present embodiment shown in FIG. 1 is an automobile including a drive source (not shown), and wheels (not shown) including drive wheels driven by power of the drive source and steered wheels that are steerable. As an example, the vehicle 1 can be a four-wheeled automobile having a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

The vehicle 1 is capable of automated driving and driving assistance, in which a driving operation is autonomously controlled to drive the vehicle 1. The automated driving defined here is automated driving in which a system of the vehicle performs all driving operations such as recognizing or monitoring a travel environment and surrounding situations, as well as starting, accelerating and decelerating, steering, and stopping. Driving assistance is driving assistance in which the system of the vehicle performs a part of driving operations such as starting, accelerating and decelerating, steering, and stopping. In particular, in the following embodiment, an example will be described in which an override is executed by a system (a control device 30 in the present embodiment) in order to stabilize a behavior of the vehicle 1 when an abnormality in a travel state of the vehicle 1 is detected. The abnormality in the travel state of the vehicle 1 is assumed to occur, for example, when acceleration of the vehicle 1 is equal to or greater than a threshold value, or when the vehicle 1 deviates from a host lane that is a lane on which the vehicle 1 is traveling (hereinafter also referred to as a “host lane”). A specific content will be described later.

The vehicle 1 includes a sensor group 10, a navigation device 20, the control device 30 that is an example of the “vehicle control device” in the present disclosure, an electric power steering (EPS) system 40, a driving force control system 50, a braking force control system 60, and a communication unit 70.

The sensor group 10 includes an external sensor 11 that acquires information related to surroundings of the vehicle 1, and a vehicle sensor 12 that acquires information related to the vehicle 1. Information (in other words, detection values) acquired by each sensor in the sensor group 10 is output to the control device 30.

The external sensor 11 includes, for example, a camera 111, a sonar 112, and a radar 113. The camera 111 is a digital camera that images the surroundings of the vehicle 1 including a front of the vehicle 1 and outputs image data of an obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves to a periphery of the vehicle 1 (for example, the front, a rear, and lateral sides of the vehicle 1), and receives reflected sounds from an object present in the periphery of the vehicle 1, thereby detecting a distance to the object, a direction of the object, and the like. The radar 113 emits radio waves to the periphery of the vehicle 1 including the front of the vehicle 1, and receives reflected waves from an object present in the periphery of the vehicle 1, thereby detecting a distance to the object, a direction of the object, and the like. The radar 113 may be, for example, a millimeter wave radar.

The external sensor 11 may include light detection and ranging (LiDAR) instead of or in addition to the sonar 112 and the radar 113. In this case, the LiDAR emits laser light to the periphery of the vehicle 1 including the front of the vehicle 1, and receives reflected light from an object present in the periphery of the vehicle 1, thereby detecting a distance to the object, a direction of the object, and the like.

The vehicle sensor 12 includes, for example, a wheel sensor 121, a vehicle speed sensor 122, an inertial measurement unit (EIU) 123, an occupant camera 124, and a steering touch sensor 125.

The wheel sensor 121 detects a rotation angle of one or more wheels of the wheels of the vehicle 1. As an example, the wheel sensor 121 detects a rotation angle of each of the left rear wheel and the right rear wheel. The wheel sensor 121 may be, for example, an angle sensor or a displacement sensor.

The vehicle speed sensor 122 detects a vehicle speed VP, which is a travel speed of the vehicle 1 (in other words, a movement speed of a vehicle body). For example, the vehicle speed sensor 122 detects the vehicle speed VP based on the number of revolutions of a countershaft (not shown) in the vehicle 1.

The inertial measurement unit 123 detects angular velocities of the vehicle 1 in a pitch direction, a roll direction, and a yaw direction, and acceleration of the vehicle 1 in a front-rear direction, a left-right direction, and an upper-lower direction. The vehicle sensor 12 may include, instead of the inertial measurement unit 123, an acceleration sensor that detects acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained vehicle interior image to the control device 30. For example, the occupant camera 124 can be a “driver monitor camera” that is provided to be able to image a head of a driver sitting in a driver seat of the vehicle 1 from the front (in other words, to image a face). Similarly to the camera 111, a digital camera using an imaging element such as a CCD or a CMOS can be adopted as the occupant camera 124. In the present embodiment, image data of a vehicle interior image obtained by the occupant camera 124 imaging the interior of the vehicle is information that can specify an orientation of a line of sight of the driver.

The steering touch sensor 125 detects whether a steering wheel 46 of the vehicle 1 is appropriately gripped. For example, the steering touch sensor 125 is implemented by a capacitance sensor or the like. In this case, the capacitance sensor is provided at a portion where the driver touches the steering wheel 46 when the steering wheel 46 is appropriately gripped.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The GNSS receiver 21 specifies the current position of the vehicle 1 (for example, a latitude and longitude of a point where the vehicle 1 is located) based on signals received from GNSS satellites. For example, the navigation device 20 may acquire a detection result of the vehicle sensor 12 (for example, the wheel sensor 121 or the vehicle speed sensor 122) via the control device 30, and may specify or complement the current position of the vehicle 1 based on an inertial navigation system (INS) using a detection value of the vehicle sensor 12.

The touch panel 22 is implemented by combining a display device such as a liquid crystal display or an organic light emitting diode (OLED) with a pointing device (for example, touch pad). The speaker 23 is configured to output sound to an occupant (for example, a driver) of the vehicle 1.

For example, the navigation device 20 searches for a route from a current position of the vehicle 1 to a destination set by the driver using the touch panel 22 by referring to the map information database 24. Then, the navigation device 20 performs route guidance using the touch panel 22 and the speaker 23 based on the route searched for. The navigation device 20 may cause the touch panel 22 to perform a predetermined display according to an instruction from the control device 30. A specific display will be described later. Further, the navigation device 20 may output, to the control device 30, predetermined information such as information indicating a specified current position of the vehicle 1 or information indicating an operation received via the touch panel 22.

The control device 30 is a computer that includes, for example, a processor for performing various calculations, a storage unit having a non-transitory storage medium for storing various kinds of information, and an input and output unit that controls an input and output of data between an inside and outside of the control device 30 (none of which are shown), and executes overall control of the vehicle 1. For example, the control device 30 is implemented by one electronic control unit (ECU) or by a plurality of ECUs working in cooperation with each other. Since the control device 30 performs the driving assistance such as controlling the vehicle on behalf of the driver, and the control device 30 can also be called a control device in a so-called advanced driving assistance system (ADAS ECU). Since specific examples of control executed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering wheel 46 and outputs information indicating the detected steering angle θst to the EPS ECU 45. The torque sensor 42 detects a steering torque TQ, which is a torque applied to the steering wheel 46 of the vehicle 1, and outputs information indicating the detected steering torque TQ to the EPS ECU 45.

The EPS motor 43 assists the driver in operating the steering wheel 46 by applying, according to an instruction from the EPS ECU 45, a driving force or a reaction force to a steering column 47 connected to the steering wheel 46. The resolver 44 detects a rotation angle θm of the EPS motor 43 and outputs information indicating the detected rotation angle θm to the EPS ECU 45.

The EPS ECU 45 is a computer that includes, for example, a processor for performing various calculations, a storage unit including a non-transitory storage medium for storing various kinds of information, and an input and output unit that controls an input and output of data between an inside and outside of the EPS ECU 45 (none of which are shown), and controls the EPS system 40 (for example, the EPS motor 43), and is implemented by one or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering wheel 46 to the control device 30. The steering speed ω is obtained by, for example, differentiating the steering angle θst with respect to time.

The driving force control system 50 includes a drive ECU 51, which is an example of a “control device” in the present disclosure, and is configured to control a driving force of the vehicle 1. The drive ECU 51 is a computer that includes, for example, a processor that performs various calculations, a storage unit having a non-transitory storage medium that stores various kinds of information, and an input and output unit that controls an input and output of data between an inside and outside of the drive ECU 51 (none of which are shown), and controls the driving force control system 50, and is implemented by one or more ECUs. For example, the drive ECU 51 controls a driving force output from the drive source of the vehicle 1 based on a detection value of an accelerator opening sensor 53 that detects an accelerator opening AP that is an operation amount of an accelerator pedal 52 provided in the vehicle 1 and a detection value of a shift position sensor 54 that detects a shift position Ps of a shift device (for example, a shift lever or a shift switch) (not shown). As described above, the drive source is an internal combustion engine or a motor, and the drive ECU controls an output of the internal combustion engine or the motor based on the accelerator opening AP and the shift position Ps. The drive ECU 51 can also control the driving force control system 50 (for example, a drive source) according to an instruction from the control device 30. The accelerator pedal 52 is an example of an “operator operable by a driver” and an “acceleration operator” according to the present disclosure.

The braking force control system 60 includes a braking ECU 61 and can control a braking force of the vehicle 1. The braking ECU 61 is a computer that includes, for example, a processor that performs various calculations, a storage unit having a non-transitory storage medium that stores various kinds of information, and an input and output unit that controls an input and output of data between an inside and outside of the braking ECU 61 (none of which are shown), and controls the braking force control system 60, and is implemented by one or more ECUs. For example, the braking ECU 61 controls a braking force of the vehicle 1 by controlling a brake device (not shown) provided in the vehicle 1 based on an operation of the brake pedal 62 provided on the vehicle 1. Here, the brake device includes, for example, a brake caliper, a cylinder that transmits hydraulic pressure to the brake caliper, and an electric motor that generates hydraulic pressure in the cylinder. The braking ECU 61 controls the electric motor of the brake device such that a braking force corresponding to an operation of the brake pedal 62 is generated. The braking ECU 61 can also control the braking force control system 60 according to an instruction from the control device 30. The braking ECU 61 is an example of a “braking control device” in the present disclosure, the brake device is an example of a “braking device” in the present disclosure, and the brake pedal 62 is an example of a “braking operator” in the present disclosure.

The communication unit 70 is a communication interface that communicates with an external device 2 under control executed by the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be adopted for communication between the vehicle 1 and the external device 2.

### Control Device

Next, the control device 30 will be described in detail. For example, the control device 30 executes various programs stored in the storage unit of the control device 30. In the present embodiment, the control device 30 is configured to acquire a travel state of the vehicle 1 at predetermined intervals, and if an abnormality in the travel state is detected, execute an override by the control device 30 for stabilizing a behavior of the vehicle 1. A cause of occurrence of an abnormality in the travel state of the vehicle 1 is assumed to be, for example, a case where a behavior of the vehicle 1 becomes unstable due to physical condition, such as when the driver suddenly falls ill (including a physical and a mental illness), or a case where a behavior of the vehicle 1 becomes unstable due to an abnormality in equipment, a device, or the like mounted on the vehicle 1. However, in the present embodiment, it is assumed that an abnormality occurs in a travel state of the vehicle 1 due to a physical condition such as sudden illness of the driver.

Specifically, as an example of a program recorded in the storage unit, the control device 30 executes a program that detects an abnormality in a travel state of the vehicle 1, and when the abnormality is detected, switches a control state of the control device (for example, the drive ECU 51) of a control target (for example, the drive source) (switching from a first state to a second state described later). The control device 30 includes an acquisition unit 31, a control switching unit 32, and a notification control unit 33 as functional units implemented by executing the program. In the following, processing described as being executed by the acquisition unit 31, the control switching unit 32, and the notification control unit 33 is processing implemented by the control device 30.

The acquisition unit 31 acquires information related to a travel state of the vehicle 1 (hereinafter also referred to as a “travel state”). For example, the acquisition unit 31 acquires the travel state of the vehicle 1 based on a detection value (acceleration, angular acceleration) of at least the inertial measurement unit 123, among various sensors in the vehicle sensor 12, such as the wheel sensor 121, the vehicle speed sensor 122, and the inertial measurement unit 123.

The acquisition unit 31 acquires a surrounding situation of the vehicle 1. For example, the acquisition unit 31 executes sensor fusion processing on a detection value of a part or all of the camera 111, the sonar 112, and the radar 113 in the external sensor 11, and acquires a surrounding situation of the vehicle 1 based on a processing result. More specifically, the acquisition unit 31 recognizes a position, type, speed, acceleration, and the like of an object present around the vehicle 1. At this time, the acquisition unit 31 recognizes a position of the object as, for example, a position on an absolute coordinate with a representative point of the vehicle 1 (for example, a center of gravity and a center of a drive shaft) as an origin. Accordingly, a relative position between the vehicle 1 and the object present in a periphery thereof can be recognized. In the absolute coordinates, the position of the object may be represented using a representative point such as a center of gravity or a corner of the object, or may be represented as a region.

The acquisition unit 31 can also acquire a surrounding situation including a shape of a host lane on which the vehicle 1 travels. For example, the acquisition unit 31 can recognize the shape of the host lane based on a traveling lane boundary recognized from a peripheral image or the like captured by the camera 111. Here, as the traveling lane boundary, for example, a division line, a road shoulder, a curb, a separation zone, and a guard rail that define a lane are assumed.

The acquisition unit 31 can also acquire a position of the vehicle 1 with respect to the host lane (for example, a distance from the vehicle 1 to the traveling lane boundary of the host lane, or a time until the vehicle 1 reaches the traveling lane boundary of the host lane). The acquisition unit 31 may acquire a surrounding situation including other road phenomena such as a stop line, a traffic signal, and a road sign.

For example, the acquisition unit 31 can acquire a surrounding situation including an obstacle present around the vehicle 1. Here, as an obstacle, for example, another traffic participant (for example, another vehicle or a pedestrian) present around the vehicle 1, or a fallen object on a road is assumed.

The control switching unit 32 switches a control state of an ECU (for example, the drive ECU 51), which is a control device of a control target (for example, the drive source), from the first state to the second state according to a travel state of the vehicle 1 acquired by the acquisition unit 31. In the following description, unless otherwise specified, the control target is referred to as the “drive source” and the ECU that is the control device is referred to as the “drive ECU 51”.

Here, the first state and the second state will be described. In the present embodiment, the first state is a state in which an operation of the accelerator pedal 52 operated by the driver is reflected in control of the drive source. The second state is a state in which an operation of the accelerator pedal 52 operated by the driver is not reflected in control of the drive source. The first state and the second state will be specifically described using a travel pattern of the vehicle 1 described below. As in the present embodiment, in the vehicle 1 capable of driving assistance, possible travel patterns include the following three patterns. (Travel pattern 1): The vehicle travels by only an operation of a person (driver). In this case, for example, a switch (not shown) or the like that allows driving assistance to intervene is in an off state, and the driving assistance does not intervene. The driving assistance mentioned here is, for example, known Automatic Emergency Braking (AEB), Cruise Control (CC), Adaptive Cruise Control (ACC), or Lane Keep Assist System (LKAS), which is represented by, for example, an advanced operation system. Thus, the travel pattern 1 is in a state in which the operation of the accelerator pedal 52 operated by the driver is reflected in the control of the drive source, and is therefore in the first state but not in the second state. (Travel pattern 2): Driving assistance intervenes for the human operation, but a priority target of the operation is a person. In this case, for example, if a human operation intervenes while driving assistance is intervening, the human operation is given priority. Thus, the travel pattern 2 is in a state in which the operation of the accelerator pedal 52 operated by the driver is reflected in the control of the drive source, and is therefore in the first state but not in the second state. (Travel pattern 3): Although driving assistance intervenes for a human operation, a priority target of the operation is the control device 30. In this case, for example, even if a human operation intervenes while driving assistance is intervening, an operation based on an instruction of the control device 30 is given priority. In the travel pattern 3, only the operation based on the instruction of the control device 30 can be reflected without reflecting any human operation intervention. However, in the present embodiment, as described above, the control device is the drive ECU 51, and therefore controls operations related to driving (that is, operations for starting and accelerating). Specifically, an operation related to driving by the driver is prohibited, and an operation related to the driving is automatically performed based on an instruction from the control device 30. That is, even in a state in which the driver operates the accelerator pedal 52, the operation is invalidated, and a driving force based on the operation becomes “0”. In the travel pattern 3, reflection of an operation of the driver related to driving is prohibited. In other words, an operation for braking, such as an operation of the brake pedal 62 by the driver, is reflected. This is because processing executed in the present embodiment (control switching processing to be described later) is processing for ensuring safety of the vehicle 1 and other surroundings of the vehicle 1, and an operation of the driver related to braking can be said to be an operation for ensuring the safety of the vehicle 1. Thus, the travel pattern 3 is in a state in which the operation of the accelerator pedal 52 operated by the driver is not reflected in the control of the drive source, and is therefore in the second state but not in the first state.

In the following description, as described above, a first state in which the operation of the accelerator pedal 52 operated by the driver is reflected in the control of the drive source is simply referred to as the “first state”, and a second state in which the operation of the accelerator pedal 52 operated by the driver is not reflected in the control of the drive source is simply referred to as the “second state”. As another travel pattern described above, a driving operation in which only the control device 30 performs all driving operations (so-called fully automated driving) without human operation intervention can be assumed. However, in the present embodiment, since the processing is executed when an abnormality in the travel state of the vehicle 1 is detected due to, for example, the driver suddenly becoming ill, such a travel pattern is excluded.

The control switching unit 32 switches the drive ECU 51 from the first state to the second state according to the travel state of the vehicle 1. The switching is executed, for example, when acceleration of the vehicle 1 is equal to or greater than a predetermined value. Here, the acceleration is an example indicating the travel state of the vehicle 1. That is, when it is determined that the acceleration is equal to or greater than a threshold value based on the acceleration of the vehicle 1 acquired using a function of the acquisition unit 31, the control device 30 switches the drive ECU 51 from the first state to the second state. Here, the “threshold value” is, for example, an indicator that may cause an abnormality in the behavior of the vehicle 1, and is assumed to be, for example, a magnitude of the acceleration acquired when the vehicle 1 runs over a curb, and a magnitude of the acceleration acquired when the vehicle 1 suddenly starts. In particular, when the vehicle 1 runs over a curb, the acceleration may rapidly change. The threshold value may be set in advance by a manufacturer of the vehicle 1 or the like, and is assumed to be, for example, 0.2 G to 0.3 G. Thus, when the control switching unit 32 determines that the acceleration of the vehicle 1 is equal to or greater than the threshold value, the control switching unit 32 determines that the travel state of the vehicle 1 is abnormal, and switches the drive ECU 51 from the first state to the second state. That is, the control device 30 executes an override. Accordingly, when the travel state of the vehicle 1 is abnormal, the control device 30 can take the initiative to decelerate or stop the vehicle 1 or to move the vehicle 1 to a safe place. The processing of switching the drive ECU 51 from the first state to the second state is executed on the assumption that the driver operates the accelerator pedal 52 to a predetermined amount or more (that is, when the accelerator opening AP is equal to or greater than a predetermined value), for example, when the vehicle is traveling while turning on a cruise control function such as ACC or CC, or when the vehicle speed VP is equal to or greater than the predetermined vehicle speed (including coasting and the like).

On the other hand, even when the acceleration equal to or greater than the above-described threshold value is acquired, the travel state of the vehicle 1 may not be abnormal. For example, when the vehicle 1 passes through an area where there is a so-called speed bump, which is a convex structure in a parking lot or the like for prompting deceleration of the vehicle 1, or a so-called hump, which is a convex structure provided in front of a crosswalk or the like for prompting deceleration of the vehicle 1, there is a possibility that the acceleration becomes equal to or greater than the threshold value. When the vehicle 1 decelerates before passing through an area where such a speed bump or hump is provided, the acceleration may be equal to or greater than the threshold value. In such a case, when it is determined that the travel state of the vehicle 1 is abnormal, and the drive ECU 51 is switched from the first state to the second state, there is a concern that an uncomfortable feeling or discomfort is given to occupants including the driver. Therefore, when the above-described acceleration is continuously acquired for a predetermined time, the control switching unit 32 switches the drive ECU 51 from the first state to the second state. The predetermined time may be determined in advance by the manufacturer of the vehicle 1 or the like, and is assumed to be, for example, 1 sec. On the contrary, when the acceleration is not continuously acquired for a predetermined time, the control device 30 maintains the first state using the function of the control switching unit 32. That is, the acceleration equal to or greater than the threshold value detected by the vehicle 1 is determined to be due to the vehicle 1 passing through an area where a structure such as a speed bump or a hump is provided for temporarily promoting deceleration of the vehicle 1, or due to deceleration that occurs when passing through such a structure, and it is determined that the travel state of the vehicle 1 is not abnormal (in other words, normal).

One of the factors that may cause an abnormality in the travel state of the vehicle 1 is that the vehicle 1 deviates from a host lane on which it is currently traveling (in other words, deviates) and travels outside a traveling lane. For example, it is assumed that the vehicle 1 may deviate from the host lane, go over a curb, and travel on a sidewalk, or run out into and travel on an oncoming lane side. Even in such a case, it is preferable not to reflect the control related to the driving of the driver. In this case, the control switching unit 32 switches, based on a surrounding situation acquired using the function of the acquisition unit 31, the drive ECU 51 from the first state to the second state when it is determined that the vehicle 1 deviates from the host lane on which the vehicle 1 is currently traveling and is traveling outside of the traveling lane. In other words, a position of the vehicle 1 relative to the host lane, as well as curbs and the like present around the vehicle 1 are recognized by a camera 111 or the like that recognizes the surrounding situation of the vehicle 1, and if it is determined based on this recognition that the vehicle 1 is traveling outside the traveling lane, the control switching unit 32 disables an operation of the accelerator pedal 52 by the driver, and switches the drive ECU 51 from the first state to the second state so that the control device 30 takes the initiative in controlling the vehicle 1. That is, the control device 30 executes the override.

Although the above-described acceleration is acquired even when the vehicle 1 is traveling outside the traveling lane, the threshold value of the acceleration at that time may be a value smaller than when the vehicle 1 is not traveling outside the traveling lane. That is, when it is determined that the vehicle 1 is traveling outside the traveling lane, a possibility that the travel state of the vehicle 1 is abnormal is higher than when the travel state of the vehicle 1 is not traveling outside the traveling lane. Therefore, the threshold value is set small in order to ensure the safety of the vehicle 1. A threshold value of the acceleration when the vehicle is not traveling outside the traveling lane (for example, 0.2 G to 0.3 G) corresponds to a “threshold value α” described later. A threshold value of the acceleration when the vehicle is traveling outside the traveling lane corresponds to a “threshold value β” described later.

When the acceleration of the vehicle 1 traveling outside of the traveling lane is less than the threshold value, the control switching unit 32 determines that the travel state of the vehicle 1 is not abnormal and maintains the first state even if the vehicle 1 travels outside the traveling lane. As an example of such a case, for example, it is assumed that the vehicle 1 changes lanes from the host lane to an adjacent lane. In this case, there is a high possibility that the acceleration acquired to travel outside the traveling lane is less than the threshold value. Similarly, even when the acceleration when the vehicle 1 is traveling outside the traveling lane is not continuously acquired for a predetermined time, the control switching unit 32 maintains the first state. As an example of such a case, for example, it is assumed that the vehicle 1 deviates from the host lane and goes over a step and enters a parking lot. In this case, depending on a height of the step and a travel speed when entering the parking lot, there is a possibility that the acceleration equal to or greater than the threshold value may be acquired when going over the step, but a probability that the acceleration will be acquired continuously for a predetermined time is low.

After the drive ECU 51 is switched from the first state to the second state as described above, when a driver performs a predetermined operation such as an operation of turning off ignition power (IG) or an operation of putting the shift position Ps of the shift device to parking (P), the control switching unit 32 switches the drive ECU 51 from the second state to the first state. That is, when the control switching unit 32 detects that the travel state of the vehicle 1 is abnormal and changes the state of the drive ECU 51 to the second state, and then when the driver requests to drive the vehicle 1 by his or her own operation, the control switching unit 32 controls the drive ECU 51 to the first state (that is, a state in which the vehicle 1 can be driven by an operation of the driver) once, triggered by an operation to reset a state of the vehicle 1, such as turning off the ignition power of the vehicle 1 or setting the shift position Ps to parking. This is because it is preferable to take safety into consideration because the vehicle is restarted after an abnormality occurs in the travel state.

The notification control unit 33 outputs a notification regarding a predetermined operation for switching from the second state to the first state. For example, the notification control unit 33 notifies the display device such as the touch panel 22 of information on a predetermined operation for switching a state of the drive ECU 51 from the second state to the first state (that is, an operation of turning off the ignition power or an operation of putting the shift position into parking). Accordingly, for example, the driver can grasp a method of bringing the vehicle 1 into a state (that is, the first state) in which the vehicle 1 can travel by the operation of the driver by looking at the display. A notification unit by the notification control unit 33 may display the information on a display device such as the touch panel 22, and also notify a user via the speaker 23 of the navigation device 20. The display device may be a portable terminal of a driver such as a smartphone in addition to the touch panel 22 of the navigation device 20.

The notification control unit 33 may display other information in addition to information on a predetermined operation for switching from the second state to the first state as information to be displayed on the touch panel 22 or the like. The other information includes, for example, information obtained by switching the state of the drive ECU 51 (for example, information obtained by switching from the first state to the second state, information obtained by switching from the second state to the first state), and information indicating a current state of the drive ECU 51 (the first state or the second state).

### Example of Processing Executed by Control Device

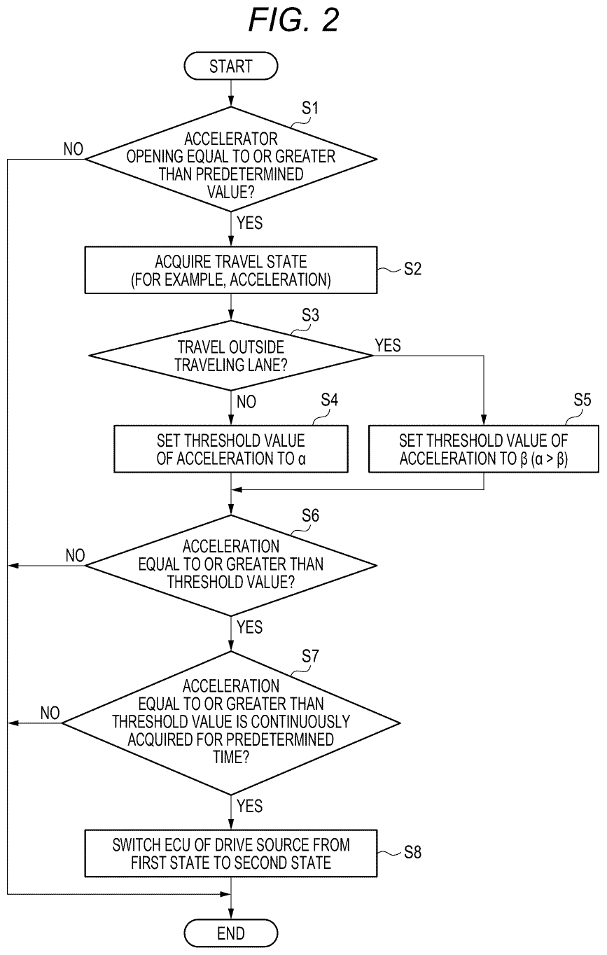

Next, an example of the control switching processing executed by the control device 30 will be described with reference to a flowchart. FIG. 2 is a flowchart showing an example of the processing, and the processing is repeatedly executed at a predetermined cycle when the ignition power of the vehicle 1 is turned on, for example.

As shown in FIG. 2, first, the control device 30 determines whether the accelerator opening AP of the accelerator pedal 52 operated by the driver is equal to or greater than a predetermined value (step S1). That is, the control device 30 determines whether the accelerator opening AP acquired from the accelerator opening sensor 53 is equal to or greater than a predetermined value. If it is determined that the accelerator opening AP is less than the predetermined value, the control device 30 ends the processing of the flowchart shown in FIG. 2.

On the contrary, if it is determined that the accelerator opening AP is equal to or greater than the predetermined value, the control device 30 acquires a travel state of the vehicle 1 (step S2). That is, the control device 30 acquires acceleration of the vehicle 1 using the function of the acquisition unit 31.

Next, the control device 30 determines whether the vehicle 1 is traveling outside a traveling lane (step S3). That is, using the function of the control switching unit 32, the control device 30 determines whether the vehicle 1 deviates from a host lane and is traveling outside the traveling lane based on a surrounding situation of the vehicle 1 acquired by the acquisition unit 31. In step S3, if it is determined that the vehicle 1 is not traveling outside the traveling lane (No in step S3), the control device 30 sets a threshold value of the acceleration to a (hereinafter also referred to as “threshold value α”) (step S4), and the processing proceeds to step S6.

On the other hand, in step S3, if it is determined that the vehicle 1 is traveling outside the traveling lane (Yes in step S3), the control device 30 sets the threshold value of the acceleration to R (hereinafter also referred to as “threshold value β”) (step S5), and the processing proceeds to step S6. As described above, the threshold value β that is set when the vehicle is traveling outside the traveling lane is set to a value smaller than the threshold value a that is set when the vehicle is not traveling outside the traveling lane (α>β), taking into consideration a high possibility that an abnormality occurs due to traveling outside the traveling lane.

In step S6, the control device 30 determines whether the acceleration is equal to or greater than a threshold value. That is, the control device 30 determines whether the acceleration of the vehicle 1 acquired in step S2 is equal to or greater than the threshold value. If it is determined in step S3 that the vehicle 1 is not traveling outside the traveling lane, it is determined whether the acceleration of the vehicle 1 acquired in step S2 is equal to or greater than the threshold value α. On the other hand, if it is determined in step S3 that the vehicle 1 is traveling outside of the traveling lane, it is determined whether the acceleration of the vehicle 1 acquired in step S2 is equal to or greater than the threshold value β. In the following description, when the threshold value α and the threshold value β are not particularly distinguished, the threshold value α and the threshold value β are simply referred to as “threshold value”.

In step S6, if it is determined that the acceleration of the vehicle 1 is less than the threshold value (No in step S6), the control device 30 ends the processing of the flowchart in FIG. 2. That is, if it is determined that the acceleration of the vehicle 1 is less than the threshold value regardless of whether the vehicle 1 is traveling outside of the traveling lane, the control device 30 ends the series of processing in FIG. 2. In the present embodiment, even when the vehicle 1 is traveling outside of the traveling lane, when the acceleration is less than the threshold value β, as described above, it is determined that the vehicle 1 is traveling outside the traveling lane, for example, when the vehicle 1 changes lanes or enters a parking lot, and it is determined that no abnormality occurs.

On the contrary, in step S6, if it is determined that the acceleration of the vehicle 1 is equal to or greater than the threshold value (Yes in step S6), the control device 30 determines whether the acceleration equal to or greater than the threshold value is continuously acquired for a predetermined time using the function of the control switching unit 32 (step S7). As described above, this processing is processing for eliminating such an event even if the acquired acceleration is equal to or greater than the threshold value, because there is a possibility that the acceleration occurs when the vehicle 1 passes through an area where a speed bump or a hump is provided. That is, if the acceleration equal to or greater than the threshold value is continuously acquired for a predetermined time (in other words, the acceleration equal to or greater than the threshold value is continuously acquired), the control device 30 determines that the travel state of the vehicle 1 is abnormal. Therefore, if it is determined in step S7 that the acceleration equal to or greater than the threshold value is not continuously acquired for the predetermined time (No in step S7), the control device 30 ends the processing of the flowchart shown in FIG. 2.

On the other hand, if it is determined in step S7 that the acceleration equal to or greater than the threshold value is continuously acquired for the predetermined time (Yes in step S7), the control device 30 causes the processing to proceed to step S8.

In step S8, the control device 30 switches the drive ECU 51, which is an ECU of the drive source, from the first state to the second state. That is, using the function of the control switching unit 32, the control device 30 disables acceleration operations such as an operation of the accelerator pedal 52 by the driver, and switches the state of the drive ECU 51 from the first state to the second state so that the vehicle 1 is controlled under the initiative of the control device 30. That is, since it can be estimated that an abnormality occurs since the acceleration of the vehicle 1 is equal to or greater than the threshold value, the control device 30 executes an override.

Since the vehicle 1 is in a state in which an abnormality occurs, the control device 30 controls the braking ECU 61 to stop the vehicle 1, or if a current position of the vehicle 1 is a place where passage of another vehicle or a person is hindered, the control device 30 also controls the drive ECU 51 to move the vehicle 1 to a safe place such as a road shoulder. As described above, a braking force caused by a braking operation of the driver (that is, a brake operation) is reflected without being invalidated. Therefore, the control device 30 outputs a braking force that is insufficient with respect to the braking force required to decelerate or stop the vehicle 1 at predetermined deceleration from a current vehicle speed of the vehicle 1, for example.

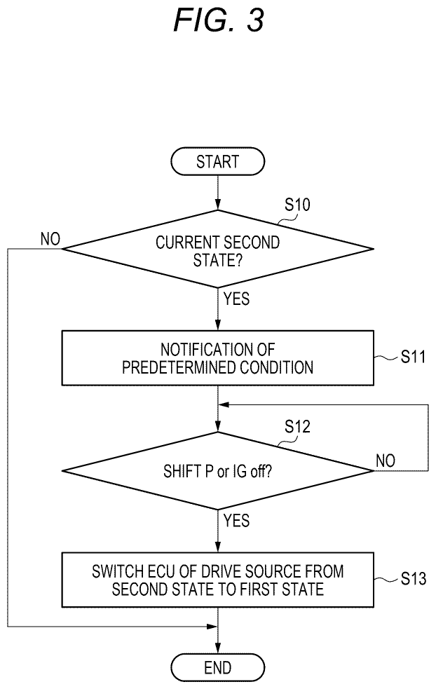

Next, processing for switching the state of the drive ECU 51 from the second state to the first state after the control device 30 switches the state of the drive ECU 51 from the first state to the second state will be described. This processing is, in other words, return processing for enabling control related to driving of the driver. FIG. 3 is a flowchart showing an example of the processing. This processing is executed when the state of the drive ECU 51 is in the second state. Therefore, the control device 30 first determines whether the state of the drive ECU 51 is in the second state (step S10). If the state of the drive ECU 51 is not the second state, in other words, in the first state (No in step S10), the control device 30 ends the processing of the flowchart shown in FIG. 3.

On the contrary, if the state of the drive ECU 51 is the second state (Yes in step S10), the control device 30 outputs a notification about a predetermined condition for switching the state of the drive ECU 51 from the second state to the first state (step S11). That is, using the function of the notification control unit 33, the control device 30 displays on a display device such as the touch panel 22 of the navigation device 20 that conditions for switching to the first state are the operation of putting the shift position Ps to parking or the operation of turning off the ignition power. Alternatively, the driver may be notified of a predetermined condition through the speaker 23.

Next, the control device 30 determines whether the shift position Ps is parking (P) or the ignition power (IG) is off (step S12). If the driver sets the shift position Ps to parking or the ignition power is turned off, a positive determination is made in step S12. On the contrary, if the driver sets the shift position Ps to a position other than parking or the ignition power is turned on, a negative determination is made in step S12.

If the shift position Ps is not parking and the ignition power is not turned off (No in step S12), the control device 30 waits until the shift position Ps is parking or the ignition power is turned off. On the contrary, if the shift position Ps is parking or the ignition power is turned off, the control device 30 switches the state of the drive ECU 51, which is the ECU of the drive source, from the second state to the first state. When the ignition power is turned off by the driver, the drive ECU 51 is in the first state again when the driver turns on the ignition power.

As described above, in the present embodiment, in accordance with the travel state of the vehicle 1, the state is switched from the first state in which an operation of the accelerator pedal 52 that can be operated by the driver is reflected in the control to the second state in which an operation of the accelerator pedal 52 is not reflected in the control (in other words, an override is executed by the control device 30). Accordingly, it is possible to appropriately switch the state to the second state in which the operation of the accelerator pedal 52 is not reflected in the control. For example, even at a state in which the physical condition of the driver becomes abnormal and the vehicle 1 cannot be driven stably, the control device 30 can take the initiative in controlling the vehicle 1 (stopping or moving the vehicle 1 away). It is possible to improve traffic safety and contribute to development of a sustainable transportation system by executing such an override by the control device 30.

In the present embodiment, the acceleration is used as a parameter for detecting an abnormality in the travel state. By using the acceleration, for example, an abnormal travel state can be detected based on a behavior of the vehicle 1 when the vehicle 1 runs over a curb or the like or when the vehicle 1 suddenly starts.

Thus, the abnormality in the travel state is determined based on the behavior of the vehicle 1. For example, compared with a case where an abnormality in the travel state of the vehicle 1 is determined using biological information of the driver, cost for detecting the abnormality can be reduced.

In the present embodiment, the abnormality in the travel state is determined based on the acceleration of the vehicle 1. When acceleration equal to or greater than the threshold value is continuously acquired for a predetermined time, an override is executed by the control device 30. Accordingly, for example, it is possible to avoid the execution of the override by the control device 30 based on the acceleration equal to or greater than the threshold value acquired due to passing through an area where a speed bump, a hump, or the like is provided.

In the present embodiment, in addition to the acceleration of the vehicle 1, when the vehicle 1 is traveling outside the traveling lane under a predetermined condition, the control device 30 executes an override. Accordingly, the travel state of the vehicle 1 can be determined based on not only the acceleration but also a surrounding situation of the vehicle 1, and the travel state can be determined more accurately.

In the present embodiment, when the vehicle 1 is traveling outside of the traveling lane, the threshold value of the acceleration is made smaller than that in a normal state in which the vehicle 1 is not traveling outside the traveling lane. This is because, when the vehicle 1 is traveling outside of the traveling lane, a possibility of occurrence of abnormality is higher than that in the normal state. Thus, by making the threshold value of the acceleration smaller than that in the normal state, there is a high possibility that the travel state of the vehicle 1 is determined to be abnormal. As a result, a possibility that the control device 30 can take the initiative in controlling the vehicle 1 can be increased.

In the present embodiment, when the accelerator opening AP based on an operation of the accelerator pedal 52 by the driver is equal to or greater than a predetermined value, the override by the control device 30 described above can be executed. That is, when the accelerator opening is at a level similar to that in which the driver is operating the vehicle himself, the override can be executed. Accordingly, when the driver is in a dangerous operating state such as a sudden illness, the override by the control device 30 is executed. Therefore, it is possible to ensure safety of the vehicle 1 and safety of those around the vehicle 1.

In the present embodiment, when the override is executed by the control device 30, an operation related to the driving of the driver is not reflected, but an operation related to the braking by the driver is reflected regardless of the travel state. Accordingly, the braking operation of the driver is reflected in a behavior of the vehicle 1, and therefore, the safety of the vehicle 1 can be improved compared with a case where the vehicle 1 is braked only by the control device 30, for example.

In the present embodiment, when the drive ECU 51 is switched from the second state to the first state, the driver is required to turn off the ignition power or to put the shift position Ps to parking. Thus, by requesting the driver to perform an operation to reset the state of the vehicle 1, it is possible to prevent a driver who may be unable to make a normal determination or perform a normal driving operation from continuing to drive the vehicle. In other words, by providing the reset operation, it is possible to increase a possibility that the vehicle 1 is caused to travel again in a state in which the driver can make a normal determination or perform a normal driving operation.

In the present embodiment, the driver is notified of the above-described reset operation via a display device such as the touch panel 22 of the navigation device 20 and the speaker 23. Accordingly, the driver can easily grasp a method of returning from the second state to the first state.

### OTHER EMBODIMENTS

Next, another embodiment will be described. In the above-described embodiment, the acceleration is used as the parameter for acquiring the travel state of the vehicle 1. However, the parameter may at least indicate a behavior of the vehicle 1. This is because whether the travel state of the vehicle 1 is abnormal can be determined as long as the parameter indicates the behavior of the vehicle 1. Another example of the parameter may be, for example, an angular velocity (or angular acceleration) of the vehicle 1. That is, the control device 30 acquires the angular velocity of the vehicle 1, and when each of the velocities is equal to or greater than a predetermined threshold value, the control device 30 executes an override.

In the above-described embodiment, when the override is executed by the control device 30, the operation related to the driving of the driver is not reflected. However, in order to more safely stop the vehicle or to move the vehicle to a safe place, it is preferable that steering of the steering wheel 46 is also controlled by the control device 30. Therefore, when an abnormality occurs in the travel state of the vehicle 1, the control device 30 may control steering of the vehicle 1 via the EPS system 40.

In the above-described embodiment, when the override is executed by the control device 30, an operation related to the braking is reflected, and an operation related to the driving of the driver is not reflected. However, in addition to the operation related to the driving, an operation related to the braking may also not be reflected. By having the control device 30 take the initiative in the operation related to the braking in addition to the operation related to driving, it is possible to increase a possibility that control of the entire vehicle will be easier than in a case where the control device 30 takes the initiative in the operation related to the driving only.

In the above-described embodiment, when the vehicle 1 is traveling outside the traveling lane and the acceleration of the vehicle 1 is less than the threshold value, the control device 30 is configured not to execute the override. However, the system may be configured to execute the override in all cases when the vehicle 1 is traveling outside the traveling lane. By not taking acceleration into account, accuracy of determining whether the travel state is abnormal decreases, but since the threshold value for the determination is looser since acceleration is not taken into account, a possibility of safely stopping the vehicle 1 can be increased.

In the above-described embodiment, the acceleration R set when the vehicle 1 is traveling outside the traveling lane is set to a value smaller than the threshold value α set when the vehicle 1 is not traveling outside the traveling lane, but the threshold value β may be the same as the threshold value α.

### Application Example

The processing of executing the override by the control device 30 as described above may be applied to the following example. Since the vehicle 1 is also capable of so-called fully automated driving, the vehicle 1 may be equipped with, for example, two systems including the control device 30 and each ECU. One of the two systems functions as a main system, and the other system functions as a backup (redundant system). In such a case, when an abnormality occurs in one of the systems and a behavior of the vehicle 1 becomes unstable, an override may be executed by the other system, and the behavior of the vehicle 1 may be stopped or moved to a safe place.

### Others

Although the embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

The control method described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements in the embodiment described above are shown in parentheses, the present disclosure is not limited thereto.

(1) A vehicle (vehicle 1) including:
an operator (accelerator pedal 52) operable by a driver;
a control device (drive ECU 51) configured to control a predetermined control target in accordance with an operation of the operator; and
a vehicle control device (control device 30) configured to control the control device, in which
the control device has a first state in which an operation of the operator is reflected in control of the control target and a second state in which an operation of the operator is not reflected in control of the control target, and is configured to switch between the first state and the second state, and
the vehicle control device includes
   an acquisition unit (acquisition unit 31) configured to acquire information related to a travel state of the vehicle, and
   a control switching unit (control switching unit 32) configured to switch the control device from the first state to the second state according to the travel state acquired by the acquisition unit.

According to (1), in accordance with the travel state of the vehicle, switching is performed from the first state in which the operation of the operator operable by the driver is reflected in the control to the second state in which the operation of the operator is not reflected in the control (in other words, the override is executed by the control device). Accordingly, it is possible to appropriately switch to the second state in which the operation of the operator is not reflected in the control. For example, even at a state in which the physical condition of the driver becomes abnormal and the vehicle cannot be driven stably, the control device can take the initiative in controlling the vehicle (stopping or moving the vehicle away). In addition, it is possible to improve traffic safety and contribute to development of a sustainable transportation system.

(2) The vehicle according to (1), in which
the acquired travel state is based on acceleration of the vehicle, and
the control switching unit switches from the first state to the second state when the acceleration is equal to or greater than a threshold value (threshold value α).

According to (2), by determining the travel state using the acceleration, for example, an abnormal travel state can be detected based on a behavior of the vehicle when the vehicle runs over a curb or the like or when the vehicle suddenly starts.

(3) The vehicle according to (2), in which the control switching unit switches from the first state to the second state when the acceleration is continuously acquired for a predetermined time, and maintains the first state when the acceleration is not continuously acquired for the predetermined time.

According to (3), it is possible to avoid execution of the override by the control device based on the acceleration equal to or greater than the threshold value acquired due to passing through an area where a speed bump, a hump, or the like is provided.

(4) The vehicle according to (1), in which
the acquisition unit acquires a surrounding situation of the vehicle, and
the control switching unit switches from the first state to the second state when the control switching unit determines that, based on the acquired surrounding situation, the vehicle deviates from a lane in which the vehicle is currently traveling and is traveling outside a traveling lane.

According to (4), the travel state of the vehicle can be determined based on not only the acceleration but also the surrounding situation of the vehicle, and the travel state can be determined more accurately.

(5) The vehicle according to (2), in which
when the control switching unit determines that the vehicle is traveling outside of a traveling lane, the control switching unit sets the threshold value of the acceleration (threshold value β) to be smaller than a threshold value when the vehicle is not traveling outside the traveling lane.

According to (5), by reducing the threshold value for when the vehicle is traveling outside the traveling lane, there is a high possibility that the travel state of the vehicle is determined to be abnormal. As a result, a possibility that the control device can take the initiative in controlling the vehicle can be increased.

(6) The vehicle according to (1), in which
the control switching unit switches from the second state to the first state when a predetermined operation (IG off or a shift position (parking P)) is performed by the driver after switching from the first state to the second state.

According to (6), it is possible to prevent a driver who may be unable to make a normal determination or perform a driving operation from continuing to drive.

(7) The vehicle according to in (6), in which
the vehicle control device further includes a notification control unit (notification control unit 33) configured to output a notification related to the predetermined operation for switching from the second state to the first state.

According to (7), the driver can easily grasp a method of returning from the second state to the first state.

(8) The vehicle according to (1), in which
the operator is an acceleration operator (accelerator pedal 52) configured to accelerate the vehicle, and the control switching unit switches from the first state to the second state when the acceleration operator is operated for a predetermined value or more.

According to (8), when the driver is in a dangerous operating state such as a sudden illness, an override by the control device is executed. Therefore, it is possible to ensure safety of the vehicle and safety of those around the vehicle.

(9) The vehicle according to (1), further including:
a braking operator (brake pedal 62);
a braking device; and
a braking control device (braking ECU 61) configured to control the braking device, in which
the braking control device reflects an operation of the braking operator in control of the braking device regardless of the travel state.

According to (9), the braking operation of the driver is reflected in a behavior of the vehicle, and therefore, the safety of the vehicle can be improved compared with a case where the vehicle is braked only by the control device, for example.

1. A vehicle comprising:
an operator operable by a driver;
a control device configured to control a predetermined control target in accordance with an operation of the operator; and
a vehicle control device configured to control the control device, wherein
the control device has a first state in which an operation of the operator is reflected in control of the control target and a second state in which an operation of the operator is not reflected in control of the control target, and is configured to switch between the first state and the second state, and
the vehicle control device includes circuitry configured to:
acquire information related to a travel state of the vehicle; and
switch the control device from the first state to the second state according to the acquired travel state.

2. The vehicle according to claim 1, wherein
the acquired travel state is based on acceleration of the vehicle, and
the circuitry switches the control device from the first state to the second state when the acceleration is equal to or greater than a threshold value.

3. The vehicle according to claim 2, wherein
the circuitry is configured to:
switch the control device from the first state to the second state when the acceleration is continuously acquired for a predetermined time; and
maintain the first state when the acceleration is not continuously acquired for the predetermined time.

4. The vehicle according to claim 1, wherein
the circuitry is configured to acquire a surrounding situation of the vehicle, and
the circuitry switches the control device from the first state to the second state when determining that, based on the acquired surrounding situation, the vehicle deviates from a lane in which the vehicle is currently traveling and is traveling outside a traveling lane.

5. The vehicle according to claim 2, wherein
when determining that the vehicle is traveling outside of a traveling lane, the circuitry sets the threshold value of the acceleration to be smaller than a threshold value used when the vehicle is not traveling outside the traveling lane.

6. The vehicle according to claim 1, wherein
the circuitry switches the control device from the second state to the first state when a predetermined operation is performed by the driver after switching from the first state to the second state.

7. The vehicle according to claim 6, wherein
the vehicle control device further includes a notification control unit configured to output a notification related to the predetermined operation for switching from the second state to the first state.

8. The vehicle according to claim 1, wherein
the operator is an acceleration operator configured to accelerate the vehicle, and
the circuitry switches the control device from the first state to the second state when the acceleration operator is operated for a predetermined value or more.

9. The vehicle according to claim 1, further comprising:
a braking operator;
a braking device; and
a braking control device configured to control the braking device, wherein
the braking control device reflects an operation of the braking operator in control of the braking device regardless of the travel state.
